(19) United States
(12) Patent Application Publication
(10) Pub. No.: US 2011/0079613 A1
(43) Pub. Date: Apr. 7, 2011

(54) Measuring cup structure

(76) Inventor: Chang Tsung Chih, Taichung City (TW)

(21) Appl. No.: 12/590,410

(22) Filed: Nov. 9, 2009

(30) Foreign Application Priority Data
Oct. 7, 2009 (TW) 098218439

(51) Int. Cl. B67D 7/22

(52) U.S. Cl. 222/158; 222/205

(57) ABSTRACT

A measuring cup structure comprises a drawing pipe set including a drawing tube having a lid to connect with a container, and including a seat having a hollowly conical mouth to communicate with the drawing tube; a measuring assembly including a measuring cup and an upper cap to cover the measuring cup, wherein the measuring cup includes a scale formed on an outer rim thereof to mark graduation, and includes a raised cylinder disposed on a central portion thereof, and between the cylinder and an inner side of the scale is defined a cavity, the cylinder includes a receiving chamber fixed on a bottom end thereof, and includes a hollowly conical head disposed on a top end thereof, and the mouth extends out of the head, the head includes a guiding member fitted thereon and having a conical surface to guide the liquid to the cavity.

### BACKGROUND OF THE INVENTION

1. Field of the Invention

The present invention relates to a measuring cup structure that is connected to a container to be pressed to draw liquid in the container to flow to a measuring cup, thus being operated easily.

2. Description of the Prior Art

A conventional measuring cup structure is used to calculate and mix liquids (such as oil, vinegar, wine, and drinks) together, however such conventional measuring cup is easy to leak liquids.

The present invention has arisen to mitigate and/or obviate the afore-described disadvantages.

### SUMMARY OF THE INVENTION

The primary object of the present invention is to provide a measuring cup structure that is connected to a container to be pressed to draw liquid in the container to flow to a measuring cup, thus being operated easily.

To achieve the above object, a measuring cup structure provided in accordance with a preferred embodiment of the present invention comprises:

a drawing pipe set including a drawing tube and a seat, wherein the drawing tube includes a lid disposed on one end thereof to connect with a container, and the seat includes a hollowly conical mouth extending from a central portion thereof to communicate with the drawing tube;

a measuring assembly including a measuring cup and an upper cap to cover the measuring cup, wherein the measuring cup includes a scale formed on an outer rim thereof to mark graduation, and includes a raised cylinder disposed on a central portion thereof, and between the cylinder and an inner side of the scale is defined a cavity, the cylinder includes a receiving chamber fixed on a bottom end thereof, and includes a hollowly conical head disposed on a top end thereof, and the mouth extends out of the head, the head includes a guiding member fitted thereon and having a conical surface to guide the liquid to the cavity;

wherein the drawing tube includes a lid with internal threads disposed on one end thereof to screw with the container with threads and having a groove mounted on a central portion of the lid to communicate with the drawing tube, and the connecting hose includes a sleeve inserted to one end thereof, and the groove includes a spring fitted therein to abut against the sleeve, another end of the connecting hose is fitted to a hollow loop, one end of which is fixed to the lip to close the groove so that the sleeve of the connecting hose is biased against the spring;

wherein the internal threads of the lid of the drawing pipe set screws with a flexible plug with outer threads, and the plug includes a plurality of sealing members disposed therein to be engaged with the container tightly;

wherein the seat includes a plurality of magnetic blocks disposed on a top side thereof, and a positioning member of the measuring assembly includes a central hole mounted on a central portion of another end thereof to retain an iron ring so that the iron ring attaches with the magnetic blocks of the seat.

### BRIEF DESCRIPTION OF THE DRAWINGS

FIG. 1 is a perspective view showing the assembly of a measuring cup structure in accordance with a preferred embodiment of the present invention;

FIG. 2 is a perspective view showing the exploded components of the measuring cup structure in accordance with the preferred embodiment of the present invention;

FIG. 3 is a perspective view showing the exploded components of a measuring up, an upper cap, and a drawing pipe set of the measuring cup structure in accordance with the preferred embodiment of the present invention;

FIG. 4 is a perspective view showing the upper cap of the measuring cup structure being removed;

FIG. 5 is a cross sectional view showing the assembly of the measuring cup structure in accordance with the preferred embodiment of the present invention;

FIG. 6 is a cross sectional view showing the measuring cup structure of the present invention being connected to a container with threads;

FIG. 7 is a cross sectional view showing the operation of the measuring cup structure in accordance with the preferred embodiment of the present invention;

FIG. 8 is a cross sectional view showing the measuring cup structure of the present invention being connected to a container without threads.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

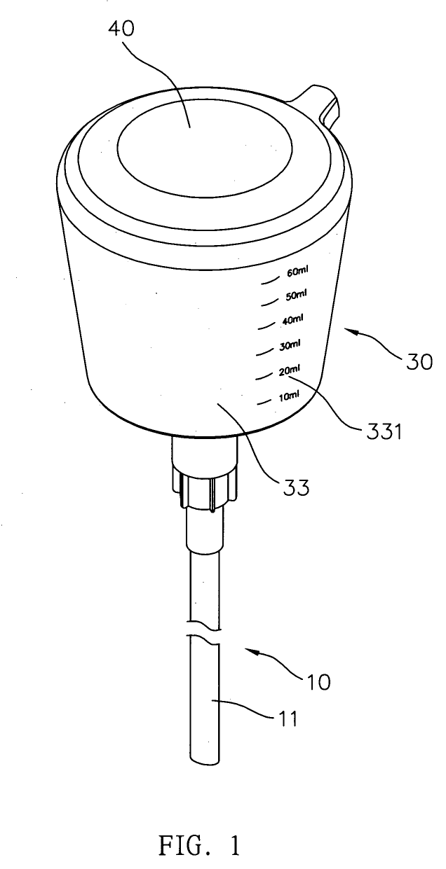

Referring to FIG. 1, a measuring cup structure in accordance with a preferred embodiment of the present invention comprises a measuring assembly 30 and a drawing pipe set 10 connected to an opening of a predetermined container, and the measuring assembly 30 is pressed to draw liquid into a measuring cup 33 of the measuring assembly 30.

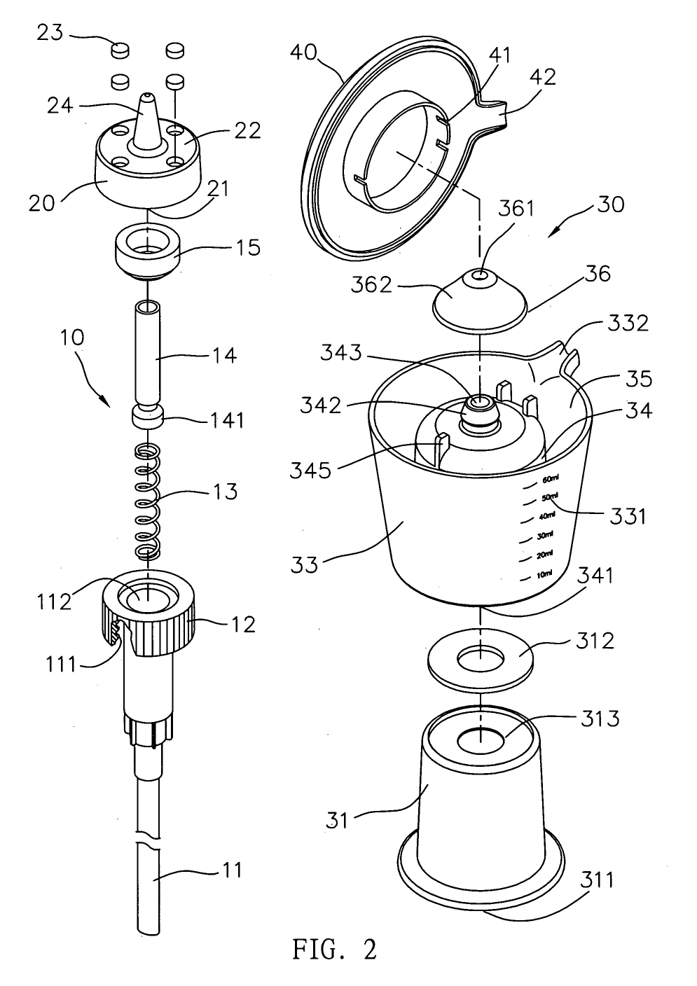

As shown in FIGS. 2, 3, and 5, the drawing pipe set 10 includes a drawing tube 11, a flexible connecting hose 14, a seat 20, wherein the drawing tube 11 includes a lid 12 with internal threads 111 disposed on one end thereof and having a groove 112 mounted on a central portion of the lid 12 to communicate with the drawing tube 11, and the connecting hose 14 includes a sleeve 141 inserted to one end thereof, and the groove 112 includes a spring 13 fitted therein to abut against the sleeve 141, another end of the connecting hose 14 is fitted to a hollow loop 15, one end of which is fixed to the lip 12 to close the groove 112 so that the sleeve 141 of the connecting hose 14 is biased against the spring 13.

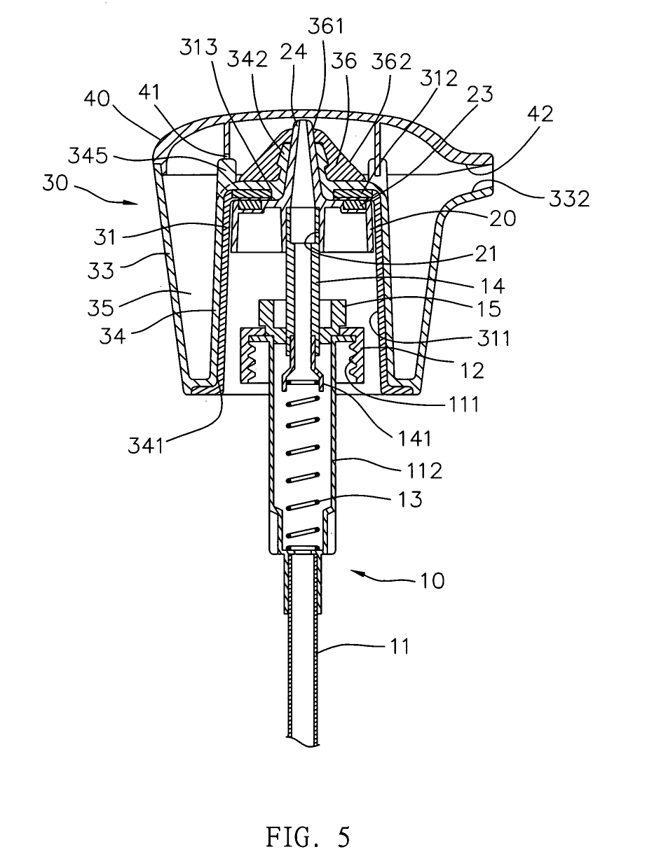

The seat 20 is formed in a hat shape as illustrated in FIG. 5, and includes a retaining recess 21 formed on a central portion of a lower end thereof to insert the seat to the connecting hose 14, and includes a plurality of magnetic blocks 23 disposed on a top side 22 thereof, and includes a hollowly conical mouth 24 extending from a central portion of the top side 22 thereof to communicate with the connecting hose 14 and the drawing tube 11.

The measuring assembly 30 as shown in FIGS. 2 and 5 includes a positioning member 31, a measuring cup 33, an upper cap 40, wherein the positioning member 31 is formed in a hollow hat shape and includes an orifice 311 disposed on one end thereof to receive the seat 20, and includes a central hole 313 mounted on a central portion of another end thereof to retain an iron ring 312 attaching with the magnetic blocks 23 of the seat 20, and the central hole 313 serves to extend the mouth 24 outward. The measuring cup 33 includes a scale 331 formed on an outer rim thereof to mark graduation. As shown in FIGS. 2, 3, and 5, a raised bell-shaped cylinder 34 is disposed on a central portion of the measuring cup 33, and between the cylinder 34 and an inner side of the scale 331 is defined a cavity 35, the cylinder 34 includes a receiving chamber 341 fixed on a bottom end thereof to engage with the positioning member 31, and includes a hollowly conical head 342 disposed on a top end thereof and having an aperture 343 mounted on a central portion of the head 342 so that the seat 20 abuts against the orifice 311 of the positioning member 31, and the mouth 24 inserts through the central hole 313 and the aperture 343 to extend out of the head 342, the head 342 includes a plastic guiding member 36 fitted thereon and having a conical surface 362 to guide the liquid from the mouth 24, and having a bore 361 to engage with the mouth 24, thus preventing the mouth 24 from leaking liquid, the cylinder 34 also includes a plurality of tabs 345 located on an outer side of the top end thereof, and the measuring cup 33 includes a channel 332 formed on a top end thereof.

The upper cap 40 is used to cover the measuring cup 33 as illustrated in FIGS. 2 and 5, and includes a number of slots 41 arranged on a lower end wall thereof to retain with the tabs 345, and includes a tunnel 42 extending from an outer side thereof to correspond to the channel 332, thereby flowing the liquid from the measuring cup 33.

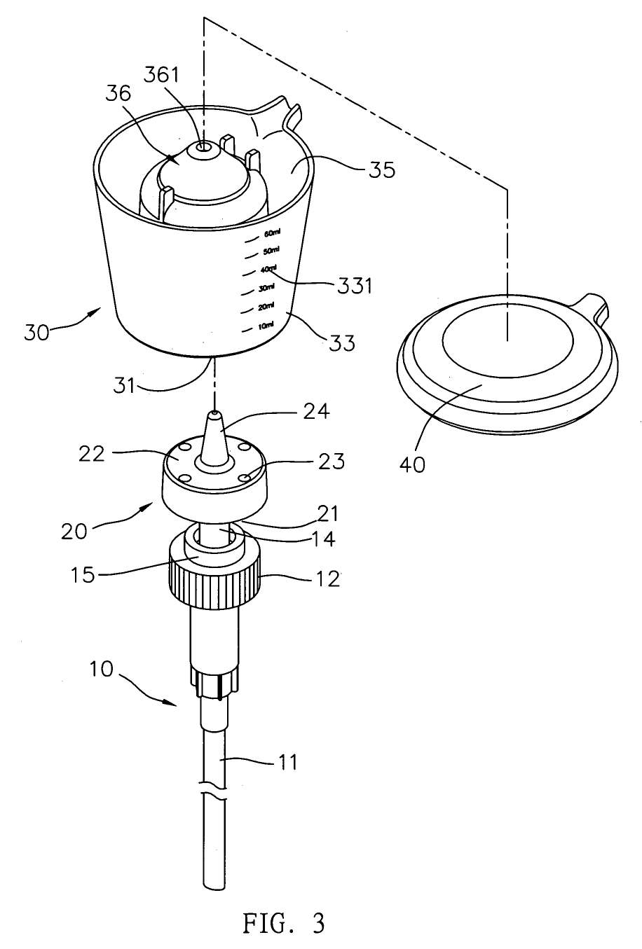

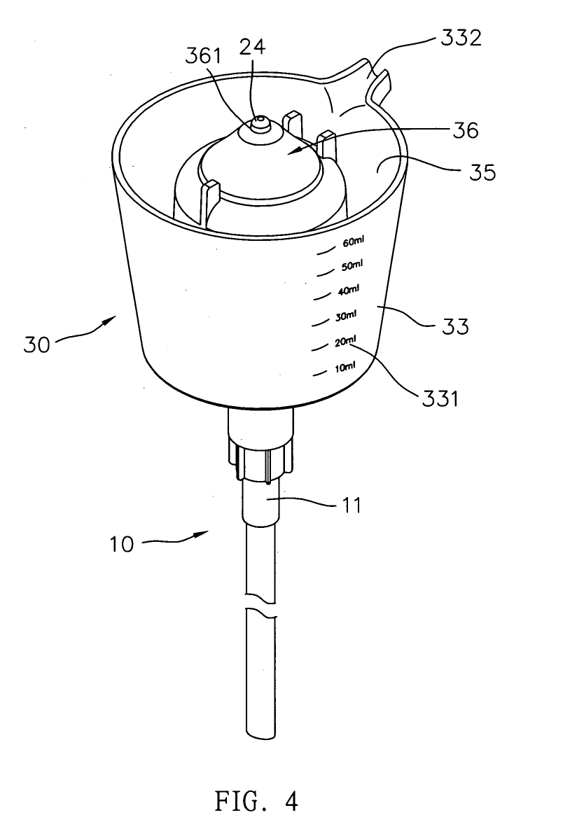

In assembly, as shown in FIGS. 3 and 5, the drawing pipe set 10 is inserted to the positioning member 31 of the measuring assembly 30 by using the seat 20 until the magnetic blocks 23 magnetically attach to the iron ring 312 of the positioning member 31, and the mouth 24 extends out of the head 342 via the central hole 313 and the aperture 343. Thereafter, the bore 361 of the guiding member 36 is forced to the head 342 to prevent the liquid from leak, and the conical surface 362 serves to guide the liquid as illustrated in FIGS. 1 and 4.

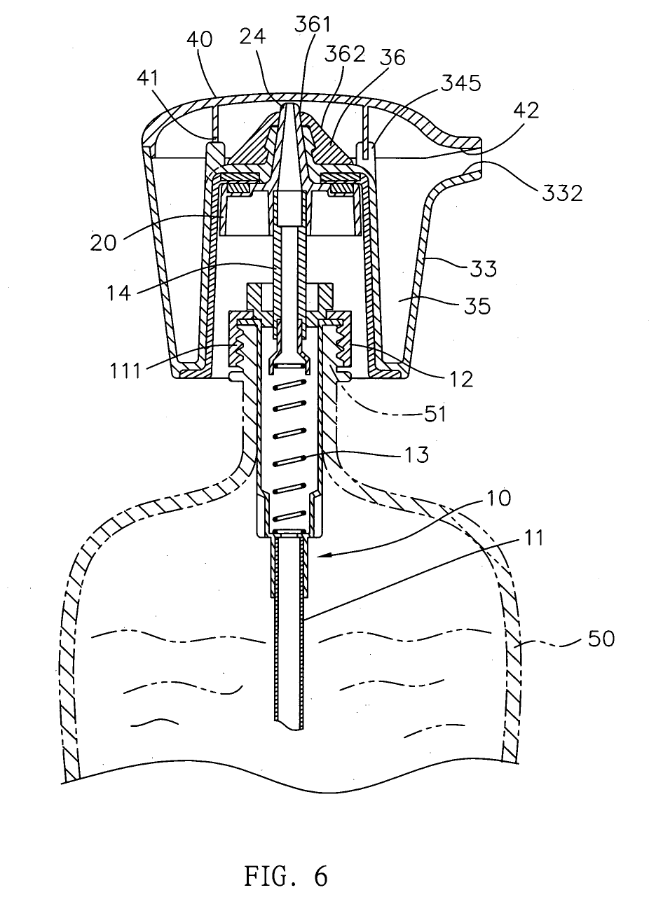

In operation as shown in FIG. 6, the drawing pipe set 10 is inserted to a container 50 with threads by ways of the drawing tube 11 so that the internal threads 111 of the lid 12 screws with an outlet 51 of the container 50, positioning the measuring assembly 30 and the drawing pipe set 10 in the container 50.

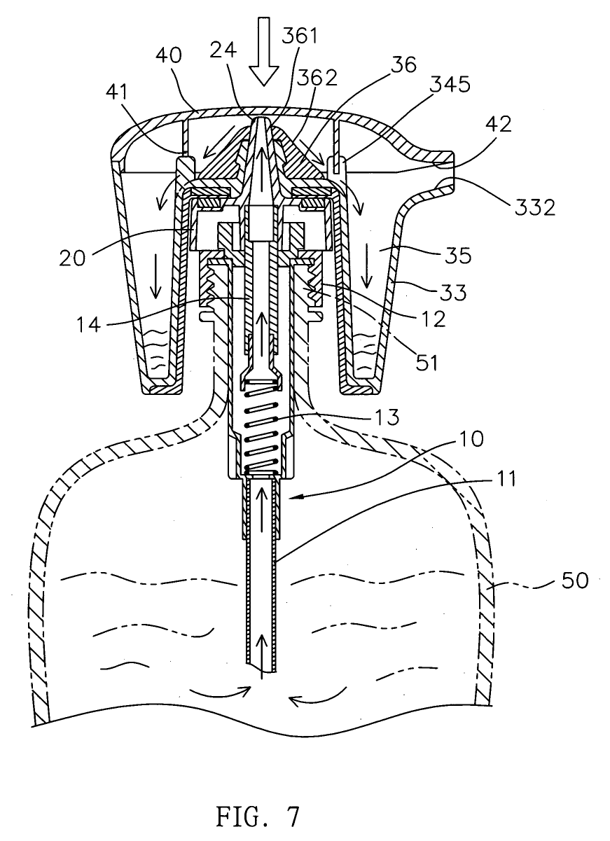

With reference to FIGS. 1, 7, and 8, the upper cap 40 of the measuring assembly 30 is pressed so that the positioning member 31 moves downward with the seat 20, and the connecting hose 14 abuts against the spring 13 to draw the liquid in the container 50 to flow through the connecting hose 14 and the mouth 24, and further to be guided to the cavity 35 by using the conical surface 362. Thereafter, the user is capable of calculating required liquid by using the scale 331 of the container 50, and then removing the upper cap 40 and pouring the liquid outward from the measuring cup 33 through the channel 332 and the tunnel 42.

As desiring to mix the liquid, the drawing pipe set 10 is released to the container 50, and then another container is installed so that the drawing pipe set 10 draws other liquids into the cavity 35, hence different liquids are fed to the cavity 35 to mix together without using the measuring cup. Besides, the upper cap 40 covers the measuring assembly 30 tightly to prevent the liquid from leak.

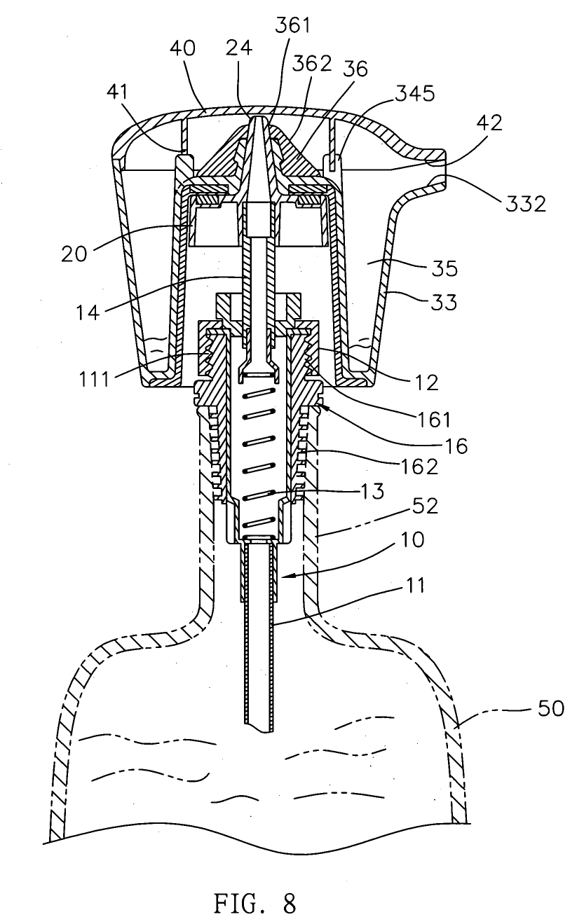

Referring further to FIG. 8, the measuring cup structure of the present invention allows to be used in a container 52 without threads as well, wherein the internal threads 111 of the lid 12 of the drawing pipe set 10 screws with a flexible plug 16 with outer threads 161, and the plug 16 includes a plurality of sealing members 162 disposed therein to be engaged with the container 52 tightly.

While we have shown and described various embodiments in accordance with the present invention, it is clear to those skilled in the art that further embodiments may be made without departing from the scope of the present invention.

What is claimed is:

1. A measuring cup structure comprising:
a drawing pipe set including a drawing tube and a seat, wherein the drawing tube includes a lid disposed on one end thereof to connect with a container, and the seat includes a hollowly conical mouth extending from a central portion thereof to communicate with the drawing tube;
a measuring assembly including a measuring cup and an upper cap to cover the measuring cup, wherein the measuring cup includes a scale formed on an outer rim thereof to mark graduation, and includes a raised cylinder disposed on a central portion thereof, and between the cylinder and an inner side of the scale is defined a cavity, the cylinder includes a receiving chamber fixed on a bottom end thereof, and includes a hollowly conical head disposed on a top end thereof, and the mouth extends out of the head, the head includes a guiding member fitted thereon and having a conical surface to guide the liquid to the cavity.

2. The measuring cup structure as claimed in claim 1, wherein the drawing tube includes a lid with internal threads disposed on one end thereof to screw with the container with threads and having a groove mounted on a central portion of the lid to communicate with the drawing tube, and the connecting hose includes a sleeve inserted to one end thereof, and the groove includes a spring fitted therein to abut against the sleeve, another end of the connecting hose is fitted to a hollow loop, one end of which is fixed to the lip to close the groove so that the sleeve of the connecting hose is biased against the spring.

3. The measuring cup structure as claimed in claim 1, wherein the internal threads of the lid of the drawing pipe set screws with a flexible plug with outer threads, and the plug includes a plurality of sealing members disposed therein to be engaged with the container tightly.

4. The measuring cup structure as claimed in claim 1, wherein the seat includes a plurality of magnetic blocks disposed on a top side thereof, and a positioning member of the measuring assembly includes a central hole mounted on a central portion of another end thereof to retain an iron ring so that the iron ring attaches with the magnetic blocks of the seat.
